(19) United States
(12) Patent Application Publication
(10) Pub. No.: US 2024/0095702 A1
(43) Pub. Date: Mar. 21, 2024

(54) User Content Generation With Receipt-Embedded Encodings

(71) Applicant: Google LLC, Mountain View, CA (US)

(72) Inventor: Joseph Turner, San Mateo, CA (US)

(21) Appl. No.: 17/798,730

(22) PCT Filed: Mar. 29, 2022
(86) PCT No.: PCT/US2022/022289

§ 371 Date: Oct. 5, 2023

(51) Int. Cl. G06Q 20/20; G06Q 30/0282

(52) U.S. Cl. CPC G06Q 20/20; G06Q 30/0282

(57) ABSTRACT

Aspects of the disclosure provide for verifying user-generated content (UGC). When the UGC is a review of an entity of a good or service, the review is verified when a UGC verification system determines that the user authoring the review was a consumer of a good or service offered by the entity. At the time of a transaction for a good or service, the UGC verification system can receive and respond to a request by a point-of-sale (POS) system to generate a unique encoding. The POS system may be implemented on a device in communication with, but separate from, a platform implementing the UGC verification system. The UGC verification system tracks receipt of requests to access a content form for leaving a review, so as to ensure that each generated encoding is only used to access the content form once.

### BACKGROUND

User-generated content (UGC) is any form of content provided by users, for example, users of an online platform, such as a social media platform, a website, or a frontend for search results of a search engine. UGC can include user-generated reviews of goods or services provided by various entities, such as vendors or service providers, and can be sent to a computing device by the platform in response to a search query, alongside information for goods or services reviewed.

A verified user review of an entity is a review by a user who has been determined to have purchased a good or service provided by a reviewed entity. Unverified reviews are reviews by users who have not been determined to have purchased a good or service provided by the reviewed entity. The overall rating and reviews of an entity can be skewed by unverified reviews, for example, when the entity receives news coverage and is flooded with arbitrary positive and/or negative reviews by users who have never used a good or service provided by the entity. Unverified reviews may also include machine-generated reviews, which, in the aggregate, may further skew the reliability of the reviews.

### BRIEF SUMMARY

Aspects of the disclosure provide for verifying user-generated content (UGC). When the UGC is a review of an entity of a good or service, the review is verified when a UGC verification system determines that the user authoring the review was a consumer of a good or service offered by the entity. At the time of a transaction for a good or service, the UGC verification system can receive and respond to a request by a point-of-sale (POS) system to generate a unique encoding. The POS system may be implemented on a device in communication with, but separate from, a platform implementing the UGC verification system. The UGC verification system tracks receipt of requests to access a content form for leaving a review, so as to ensure that each generated encoding is only used to access the content form once.

For example, the encoding can be a quick response (QR) code printed on a paper receipt or provided in an email receipt to a user that is party to a transaction executed by the POS system. The encoding can embed a Uniform Resource Loader (URL) that points to a content form with a user-interactable element configured to receive UGC. Upon receiving a request including the embedded URL, the UGC verification system determines whether the URL has been received in a previous request. If not, the UGC verification system is configured to transmit UGC received through the content form to one or more computing devices, as verified user content.

Aspects of the disclosure provide for verifying user content even when the transaction is performed by a system different than a system or platform verifying the UGC. For instance, a point-of-sale (POS) system may perform a transaction between a user and an entity, and the entity may be subject to review by user reviews published on a computing platform, such as a platform implementing a search engine. Because the POS system and the platform are not managed by the same entity, the platform may not have access to transaction data available only on the POS system. Aspects of the disclosure provide for integrating the POS system with the UGC verification system, such that the user-generated reviews can be verified for a larger variety of transactions not executed by the computing platform.

Aspects of the disclosure provide for a method, including: receiving, by one or more processors, a first request from a computing device to access a content form, the first request including a uniform resource locator (URL); determining, by the one or more processors, that the URL of the first request was not previously received in another request; and in response to determining that the URL of the first request was not previously received in another request, providing, by the one or more processors, the computing device access to the content form.

Aspects of the disclosure provide for a system, including: one or more processors, the one or more processors configured to: receive a first request from a computing device to access a content form, the first request including a uniform resource locator (URL); determine that the URL of the first request was not previously received in another request; and in response to the determining that the URL of the first request was not previously received in another request, provide the computing device access to the content form.

Aspects of the disclosure provide for one or more computer-readable storage media, which may be non-transitory, storing instructions that are operable, when executed be one or more processors, to cause the one or more processors to perform operations including: receiving a first request from a computing device to access a content form, the first request including a uniform resource locator (URL); determining that the URL of the first request was not previously received in another request; and in response to determining that the URL of the first request was not previously received in another request, providing the computing device access to the content form.

Aspects of the disclosure can provide for at least the following technical advantages. Generated content can be verified as provided by a user in connection with the subject of the generated content, for example a customer or consumer of goods or services provided by an entity, such as a vendor. A wider variety of transactions can serve as the basis of verifying a review, increasing the number of available reviews overall. As a result, a platform implementing a search engine can more accurately rank search results according to rankings and reviews provided by users from a wider and more accurate set of reviews.

The UGC verification system as described herein ensures that content provided in response to a request including a generated URL is only marked as verified once, effectively making the URL one-time-use for providing verified content. By enforcing this one-time-use condition, the UGC verification system can mitigate or eliminate the risk that the URL is used to generate multiple reviews, enforcing the condition that a verified review is a review of an entity based on a single transaction between the entity and a user. One-time-use of the URLs, besides enforcing notions of fairness on the platform providing a medium for user-submitted reviews of entities like vendors or restaurants, also prevents undue weight being placed on duplicate reviews, which can have the effect of skewing content recommendation or search engine result ranking performed by the platform implementing the UGC system.

Tracking whether or not a URL has been previously received as a basis for determining whether or not to mark a user review as verified also improves the versatility of platforms managing reviews corresponding to search results of a search engine. For example, aspects of the disclosure augment existing platforms managing user reviews, for example by extending the range of possible transactions to cash transactions, and/or transactions local to a POS system, in which transaction data is not immediately available to the platform. Further, as largely any network-capable device is configured to receive and interpret data specifying a URL, POS systems of a variety of different types can be integrated with the UGC verification system along a standard interface, e.g., using HTTP requests.

Aspects of the disclosure can provide for one or more of the following features. In some examples, aspects of the disclosure provide for all of the following features, in combination.

The method further includes generating, by the one or more processors, an encoding of the URL according to a predetermined encoding/decoding scheme. The encoding can be a quick response (QR) code or a data matrix code.

Aspects of the disclosure can provide for at least the following technical advantages. By relying on a predetermined encoding/decoding scheme, for example a scheme for encoding the URL as a QR code or data matrix code, the URL can be encoded in a format that is most likely to be readable by a variety of different user devices, for example using a camera and a scanning application that is often built-in to popular mobile device operating systems. By encoding the URL, the URL can be embedded in a wider variety of formats, for example in paper receipts, allowing users to quickly access content forms to provide user content, even when accessing the URL through a physical medium. Additionally, providing the URL as part of an encoding allows for additional metadata to be encoded, such as data specifying characteristics of the transaction, and/or parties to the transaction.

Transmitting, by the one or more processors, can further include transmitting the encoding of the URL to the computing device.

Aspects of the disclosure can provide for at least the following technical advantages. By transmitting the encoding of the URL to the computing device, the computing device can directly receive the encoding for accessing a content form provided through the URL. In doing so, aspects of the disclosure can further improve the range of POS systems that can be integrated with the UGC verification system, for example because direct transmission of the encoded URL may be necessary when a POS system is not equipped to provide a digital or physical copy of the encoding itself. As described herein, increasing accessibility of POS systems performing transactions that are used for verifying user reviews increases the overall amount of reliable, e.g., verified, reviews.

Transmitting, by the one or more processors, can further include transmitting the encoding of the URL to a point-of-sale (POS) system in response to receiving an indication of a transaction of a good or service executed by the POS system.

Aspects of the disclosure can provide for at least the following technical advantages. The generation and transmission of the encoding can be performed automatically in response to receiving an indication of a transaction. For POS systems receiving large volumes of transactions, the UGC verification system can enqueue and process requests to generate encodings during times of high activity. The transaction between an entity and a user is therefore not susceptible to delay on account of potential high volumes of transactions. The POS system can subsequently send the encoding to a user computing device, e.g., through email or direct message.

The encoding further includes metadata including one or more of: data characterizing the transaction, data characterizing the POS system, or data characterizing the computing device.

Aspects of the disclosure provide for at least the following technical advantages. The additional encoded data can be analyzed later for identifying trends and patterns on the transaction history of the POS system, even if the POS system does not natively provide for saving transaction data. Further, data received by the UGC verification system for encoding the URL and the additional data can be saved on the platform implementing the system, which can be further configured to analyze trends or patterns on behalf of the POS system.

The content form includes a user-interactable element for a user review of an entity that is a party to the transaction of the good or service, and wherein the one or more processors are further configured to: receiving, by the one or more processors, user content through the user-interactable element of the content form; and in response to determining the URL of the first request was not previously received in another request, transmitting, by the one or more processors, the user content to one or more computing devices with an indication that a user associated with the user content is a party to the transaction.

Aspects of the disclosure provide for at least the following technical advantages. Providing the user content with an indication of verification improves the reliability in using the content, whether by users or through automated processes. For example, entities whose information is in response to a search engine request may be weighted more heavily in appearing higher up in the search results, based on the presence of verified reviews. Additionally, more verified reviews can be used to distinguish search results that are more or less responsive to a user query, versus unverified reviews, in which their origins are less certain. As described herein, aspects of the disclosure can increase the overall number of verified reviews from transactions, including those transactions performed outside of the platform that may be publishing the verified reviews.

The one or more processors can be further configured for determining that the URL of the first request was previously received in another request, and in response, providing, by the one or more processors, the computing device access to the content form, receiving, by the one or more processors, the user content through the user-interactable element of the content form, and transmitting, by the one or more processors, the user content to the one or more computing devices with an indication that a user associated with the user content is not party to the transaction of the good or service.

Aspects of the disclosure provide for at least the following technical advantages. Access to the platform is not inhibited on account of the URL used to access the content form already being used. Rather, the platform can continue to receive content through the content form, but can indicate the content is unverified.

The encoding encodes a unique identifier, and wherein determining, by the one or more processors, that the URL of the first request was previously received includes maintaining a repository of generated unique identifiers and a respective status for each unique identifier indicating whether the unique identifier has been received in a request to access a content form.

The unique identifier is the generated URL.

Aspects of the disclosure provide for at least the following technical advantages. The UGC verification system can flexibly encode any of a variety of different unique identifiers, for example a transaction identifier for the transaction, or an identifier for the user coupled with additional data, such as a timestamp or the location of the POS system. In some examples, the URL itself can be generated uniquely using additional data, such as a transaction identifier, a timestamp, and/or a location of the POS system.

### BRIEF DESCRIPTION OF THE DRAWINGS

FIG. 1 is a block diagram of a user-generated content (UGC) verification system responding to a request by a user computing device, according to aspects of the disclosure.

FIG. 2A illustrates a web page on a device displaying verified user reviews, according to aspects of the disclosure.

FIG. 2B illustrates a web page on a device displaying verified user reviews corresponding to media elements of a media gallery, according to aspects of the disclosure.

FIG. 2C illustrates a web page on a device displaying verified user reviews for an entity location displayed on a digital map.

FIG. 3A is a flow diagram of an example process for responding to requests for generating user-verified content, according to aspects of the disclosure.

FIG. 3B is a flow diagram of an example process for responding to requests for generating unverified user content, according to aspects of the disclosure.

FIG. 4 is a flow diagram of an example process for determining whether a request through an encoded URL has been previously received, according to aspects of the disclosure.

FIG. 5 is a block diagram of an example computing environment implementing the UGC verification system, according to aspects of the disclosure.

### DETAILED DESCRIPTION

### Overview

Aspects of the disclosure provide for verifying user-generated reviews of goods or services provided by an entity, such as a vendor or restaurant owner. Verification may refer to the process by which a user-generated review is determined to have been authored by a user or purchaser of a good or service that is being reviewed. Verified reviews can be differentiated from other reviews maintained by a computing platform with an indication that the review has been verified. For instance, verified reviews may include a graphical indicator, such as a checkmark, star, or other such markings that indicates that the review is verified.

At the time of a transaction, a point-of-sale (POS) system can request that the UGC verification system generate an encoding of a unique identifier, such as a unique URL, to a content form where a user can input content, such as a review of the product or service purchased or otherwise obtained by the user. A POS system can be implemented on a computing device, for example a tablet, electronic cash register, laptop, etc., for facilitating a monetary transaction between two parties, e.g., a user and an entity providing a good or a service. The encoding can be, for example, a Quick Response (QR) code, which can be printed on a paper receipt or sent as an email receipt to a user computing device, as examples. The UGC system can receive a request including the URL. The request can be a request for accessing a content form for leaving a review for an entity, such as a restaurant.

Content can include any of a variety of formats, including text, audio, video, audiovideo content. A review can be a text, audio, or video review, which also may include additional data provided by a user computing device through a content form. The content form can include additional user-interactable elements, such as text fields, drop-down menus, and radio buttons, for receiving additional input that can form at least part of the user-generated content.

A user, for example using a camera on their mobile device, can scan the encoding and access the URL. Accessing the URL may include sending, by the mobile device of a user, a request to the computing platform to access the content form for submitting a review.

The UGC system can determine whether or not the URL has been previously accessed. In this regard, the UGC system can maintain a repository of generated URLs, and track a state of each URL for determining whether a previous request containing the URL has been received. If the URL has not been previously received, the computing platform can direct the requesting device to the content form, which can include a user-interactable element for leaving a review to an entity party to the transaction. The review can be input by the user in the content form and be marked by the computing platform as a verified review.

In some examples, the UGC verification system can further store metadata corresponding to the POS or other system for which the encoding is generated and transmitted. Using this additional metadata as context, the UGC can further verify whether the requesting device transmitting a request including the URL is actually associated with the POS system. For example, the UGC verification can compare the difference in time or location between the initial transaction causing the encoding to be generated, and the time or location from which the request with the URL is sent for accessing the content form. Based on certain predetermined thresholds, such as a maximum or minimum time at which the encoding is valid for accessing the content form, the UGC verification system can further make a determination as to whether the computing device providing the request with the URL is associated with a user party to the transaction.

In some examples, the UGC verification system at least partially implements an access rights verification process for limiting access to certain resources, such as a content form. The UGC verification system can restrict access to the content form or other resource to only devices providing a request with a previously unused URL, treating the URL as a one-time-use token to enforce the condition that the location that the URL points to is accessed only once.

If the URL has been previously received by the computing platform, the computing platform may still provide the content form in response to the request and the user may input their review into the content form. However, the review input by the user may be marked as unverified by the computing platform.

One or more computing devices may query the computing platform or other computing device for reviews associated with a particular product or service. The computing devices may query the platform, for example through a search engine, a map/navigation application, or a photo album application. In response to a query, the platform can provide verified reviews, unverified reviews, or both. For example, verified reviews can be provided and indicated as verified by a marker, such as a checkmark or a star, or some other indication. Unverfied reviews may explicitly marked as unverified, or not have any indication, in contrast to the verified reviews.

A user relying on reviews, for example, for determining whether or not to purchase a product or service, may rely more on verified reviews over unverified reviews. This is at least because, in the latter case of unverified reviews, there is a higher probability that the latter includes automated reviews by bots, or reviews by users who are “brigading” an entity online, as opposed to providing reviews for goods or services they have actually purchased or consumed.

By generating the encoding and maintaining a repository to track previous requests including the URL, aspects of the disclosure provide for decoupling transaction management and review verification. A POS system, for example managed by an entity offering a good or service for sale, can be maintained separate from a platform configured to manage user reviews published online for the entity. By generating an encoding embedding a URL or other unique identifier as described herein, a UGC verification system allows for a wider variety of transactions, for example cash transactions, or digital transactions that are not linked to a platform publishing a user-generated review.

The UGC verification system can also receive and maintain transaction-specific data that can be accessed later by an entity party to the saved transactions. For example, upon receiving a request for generating an encoding, the UGC verification system can additionally encode metadata into the encoding. For example, metadata representing the time, location, or other characteristics of the transaction may be encoded into the encoding. The UGC verification system can optionally analyze and provide statistical reports for the tracked data. Because the UGC verification system tracks the specific transaction for which a verified review was submitted, the UGC verification system can provide additional signals that can be used for content recommendation or tracking user purchasing behavior and trends.

Aspects of the disclosure can provide for at least the following technical advantages. Generated content can be verified as provided by a user in connection with the subject of the generated content. For example, a customer or consumer of goods or services provided by an entity, such as a vendor, can be verified. Verifying this connection between the user and the goods or services provided by an entity can provide for generated content that is more reliable and reflective of the characteristics of the subject of the content. Because the system can maintain a repository of used and unused encoded URLs, encodings can be designated as single-use, even if digital or physical copies are made or accessed by multiple computing devices.

In addition, generating the encoding at the point of sale creates an association between the entity facilitating the sale and the user. The association at least partially creates the reliable connection for verifying generated content provided through accessing a resource linked by the encoding, with the user who has actually interacted with the entity. Because transactions may be performed without identifying the user at the time of the transaction, for example a cash transaction, a later review can still be verified when the content form for the review is accessed by an encoding generated for the transaction. The connection can be further demonstrated by unique identifiers, such as a time-stamped identifier for a transaction between the user and the entity.

Content recommendation systems can use verified user-generated content, such as vendor reviews, to more accurately curate and rank search results responsive to received search queries. Verified user-generated content can be prioritized and relied on more heavily than unverified generated content, which may be generated by automated bots or users who are not associated with the subject of the content.

By generating an encoding embedding a URL or other unique identifier as described herein, a UGC verification system allows for decoupling the system performing the transaction from a platform providing reviews for an entity party to the transaction, while still enabling the determination of verified user reviews or other user-generated content. As a result, UGC such as reviews can be verified at a broader scale, by including transactions that are not necessarily performed by the same platform managing the reviews. Moreover, the UGC verification system can integrate a variety of different POS systems for verifying user reviews through minimal modification to the POS system itself, e.g., requiring a network connection and being configured to request and receive data to and from the platform.

By relying on a predetermined encoding/decoding scheme, for example a scheme for encoding the URL as a QR code or data matrix code, the URL can be encoded in a format that is most likely to be readable by a variety of different user devices, for example using a camera and a scanning application that is often built-in to popular mobile device operating systems. By encoding the URL, the URL can be embedded in a wider variety of formats, for example in paper receipts, allowing users to quickly access content forms to provide user content, even when accessing the URL through a physical medium. Additionally, providing the URL as part of an encoding allows for additional metadata to be encoded, such as data specifying characteristics of the transaction, and/or parties to the transaction.

By transmitting the encoding of the URL to the computing device, the computing device can directly receive the encoding for accessing a content form provided through the URL. In doing so, aspects of the disclosure can further improve the range of POS systems that can be integrated with the UGC verification system. For example, the UGC verification system may provide direct transmission of the encoded URL to a POS system, when the POS system is not equipped to provide a digital or physical copy of the encoding, itself. As described herein, increasing accessibility of POS systems performing transactions used to verify user reviews increases the overall amount of reliable (e.g., verified), reviews.

The generation and transmission of the encoding can be performed automatically in response to receiving an indication of a transaction. For POS systems receiving large volumes of transactions, the UGC verification system can enqueue and process requests to generate encodings during times of high activity. The transaction between an entity and a user is therefore not susceptible to delay on account of potential high volumes of transactions. The POS system can subsequently send the encoding to a user computing device, e.g., through email or direct message.

Additional encoded data can be analyzed later for identifying trends and patterns in the transaction history of the POS system, even if the POS system does not natively provide for saving transaction data. Further, data received by the UGC verification system for encoding the URL and the additional data can be saved on the platform implementing the system, which can be further configured to analyze trends or patterns on behalf of the POS system. The additional encoded data can be analyzed later for identifying trends and patterns in the transaction history of the POS system, even if the POS system does not natively provide for saving transaction data. Further, data received by the UGC verification system for encoding the URL and the additional data can be saved on the platform implementing the system, which can be further configured to analyze trends or patterns on behalf of the POS system.

### Example Systems

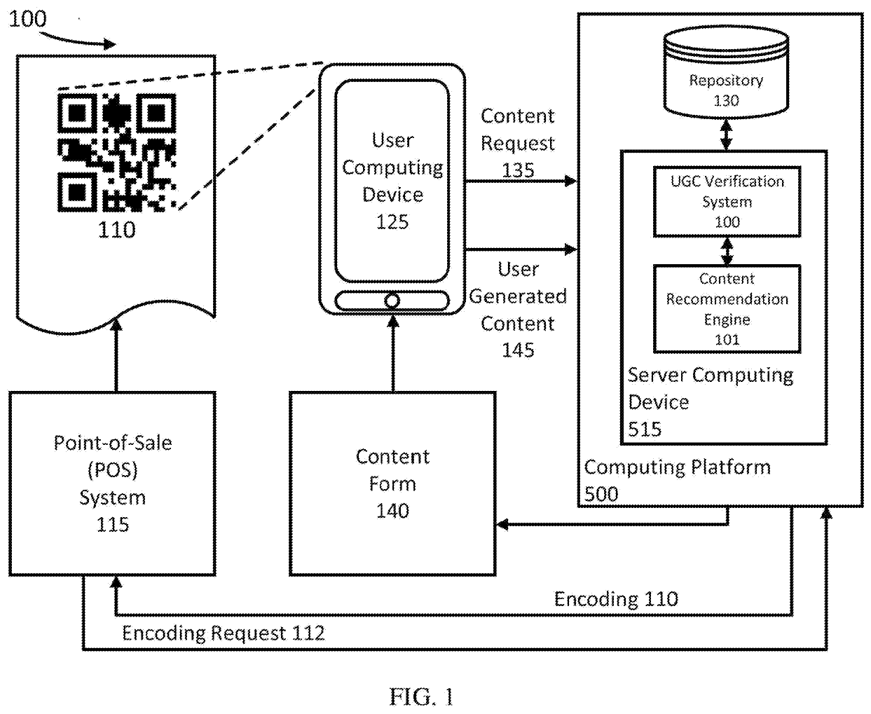

FIG. 1 is a block diagram of a user-generated content (UGC) verification system 100 responding to a request by a user computing device, according to aspects of the disclosure. A point-of-sale (POS) system 115 receives an encoding 110 from the UGC verification system 100.

The POS system can be implemented on any of a variety of types of devices, for example a laptop, mobile device, tablet, etc., and be configured for managing monetary transactions between a user and an entity in control of the POS system 115. To manage a transaction, the POS system 115 can be configured to receive input corresponding to goods or services subject to a transaction. The system 115 can receive, for example through a credit card or the user computing device, financial information specifying a means for how the user is paying for the goods or services. The system 115 can pass data characterizing the transaction to a system, such as a banking system or credit card service, for updating funds associated with either party of the transaction.

In some examples, the UGC verification system 100 can be implemented on a server computing device, such as server computing device 515 implemented on computing platform 530. The computing platform 530 is described with more detail herein.

The platform 530 can be separately maintained from the POS system 115. For example, the platform 530 can be an online computing platform offering a variety of services, such as services for providing search results, user-generated reviews of various goods, services, or entities, and/or a maps/navigation service. These services can be accessed by a variety of different computing devices, such as the user computing device 125 or the POS system 115.

An encoding can refer to any computer-readable sequence of symbols or markings. An encoding can be a raw or encoded version of a string of alphanumeric characters or bits. For example, a encoding can represent a uniform resource loader (URL) or other types of links to a resource over a network.

The encoding 110 can be printed, for example, on a receipt and provided to a user of computing device 125. In some examples, the encoding 110 can be provided as part of a digital receipt provided to the computing device 125. For example, the encoding may be provided to a user computing device, such as user computing device 125, via a text message, pop-up notification, email message, or any other such notification or message.

A receipt refers to a memorialization of a transaction between a user and an entity, facilitated by the POS system 115. For example, the POS system 115 can be a mobile device with an application configured to handle a transaction of currency for goods or services provided by an entity in control of the POS system 115. An example transaction can be paying for a meal at a restaurant, purchasing plumbing services, or purchasing a good through a retail store or online website.

The encoding 110 can be a type of barcode. For example, the encoding may be a Quick Response (QR) encoding, a data matrix encoding, code 39, code 128, interleaved 2 of 5, universal product code (UPC), international article number (EAN), PDF417, etc. In addition to commonly used barcode types as described presently, the code may be generated using an application-specific encoding/decoding scheme. In some examples, a encoding may be an image or pattern, an animation, such as a GIF.

In some examples, the encoding 110 is a one-dimensional or two-dimensional barcode. The encoding can include a grid of lines or cells, selectively filled in accordance with a predetermined encoding/decoding scheme, for example mapping sequences of cells in a encoding to alphanumeric characters. The encoding may include a finder pattern or predetermined sequence of cells used by a computing device to identify the position and orientation of the encoding, as well as the correct scheme for decoding the encoding. The encoding may be any shape, size, or orientation. In some examples, the encoding may be black and white, while in other examples the encoding may include different colors.

In some examples, the encoding 110 is a user-interactable element representing a URL, for example as part of a message, e.g., an email, a text message, a direct message on a social media platform, etc. The user computing device can send a request to access a content form linked by the hyperlink, for example through touch input to a touchscreen, mouse click, keyboard input, etc.

The POS system 115 can generate and send an encoding request 112 for receiving the encoding 110 from the UGC verification system 100. The encoding request 112 can optionally include data characterizing the transaction, the POS system 115, or the user computing device 125. Example data can include items or services exchanged during the transaction, a monetary cost for the goods or services, the location of the POS system, and the time/date at which the transaction took place. Other data characterizing the transaction or data associated with the transaction may also be included in the encoding request. The additional data sent in the encoding request 112 can be encoded as part of the encoding 110, e.g., for later retrieval of the additional data, or used in generating a unique URL.

After receiving the encoding request, the UGC verification system 100 is configured to generate an encoding including a URL for accessing content form 140. The system 100 maintains repository 130 for tracking unique identifiers corresponding to each generated encoding, as well as a status indicating whether or not the system has received the URL in a request to access content form 140. The unique identifier can be the URL itself, generated using transaction- or user-specific data. Transaction-specific data can include location data of the POS system 115 facilitating the transaction, a timestamp indicating the time at which the transaction took place, etc.

A computing device, such as user computing device 110, can be configured to scan encodings. Scanning encodings may include scanning encodings displayed on a screen or encodings printed or otherwise attached to a physical medium, such as a paper receipt, a paper sign, a sticker, etc. In some examples, the encoding may be projected onto a screen and/or rendered holographically or in a virtual environment. In some examples, the encoding may be rendered by a virtual reality or augmented reality device with a camera pointing at a fiducial marker or other physical analog for the encoding 110.

User computing device 110 may use a dedicated scanner application or implement an operating system with a pre-existing encoding scanning feature. For example, the encoding scanning feature of the operating system may be part of a camera application on the computing device, configured to automatically detect when a computer-readable encoding is within the field of vision of a camera of the computing device. In some examples, the computing device may scan encodings from saved photos or videos on the computing device.

Upon scanning or receiving user input interacting with the encoding 110, the user computing device can send a content request 135, for example as an HTTP request, to the computing platform 500.

The UGC verification system 100 can receive the content request 135, for example as an HTTP request including the encoded URL. The system 100 determines, using the repository 130, whether the URL has been received in a previous request. If the URL has not been previously received, the UGC verification system may send content form 140 to the computing device 125. After receiving the content, the system can mark the content as verified, such that when the review is sent to one or more computing devices, the review is sent with an indication that the review is verified.

The content form 140 can be a webpage or other online resource, including a user-interactable element, such as a text box, drop-down menu, etc., for receiving UGC. The content form 140 is configured such that content received through the user-interactable element is associated with the entity that was party to the transaction corresponding to the encoding 110. For example, the content form 140 can be configured so UGC 145 inputted through the content form is associated by the platform 500 as corresponding to a review of the entity party to the transaction. The platform 500 can be configured to store and publish a number of reviews received across multiple computing devices, the reviews corresponding to various different entities.

If the system 100 determines that the URL received in the content request 135 has been previously received, then the system can send the content form 140, receive UGC 145, and mark the UGC 145 as unverified. In some examples, if the system 100 determines that the URL received in the content request 135 has been previously received, then the system does not send the content form 140, at all. The system can instead reject the request and not direct the requesting device to the content form, if it is determined that the URL has previously been received.

After receiving a content request, the UGC verification system 100 can update the repository 100 to reflect that the URL in the content request 135 has been received. For example, data corresponding to whether or not the URL has been received may be initially set to indicate that the URL has not been received. After receiving the request 135, the system 100 can update the status of the data corresponding to the URL, to indicate that the URL has now been received. Thereafter, if the system 100 receives a subsequent request with the same URL, the system 100 can send the content form 140, receive the UGC 145, and associate the UGC 145 as an unverified review.

In some examples, the UGC verification system 100 can at least partially implement an access rights verification process for limiting access to the content form 140 or other online resource using generated URLs. The UGC verification system 100 can restrict access to the content form or other resource to only devices providing a request with a previously-unused URL, treating the URL as a one-time-use token to enforce the condition that the location that the URL points to is accessed only once.

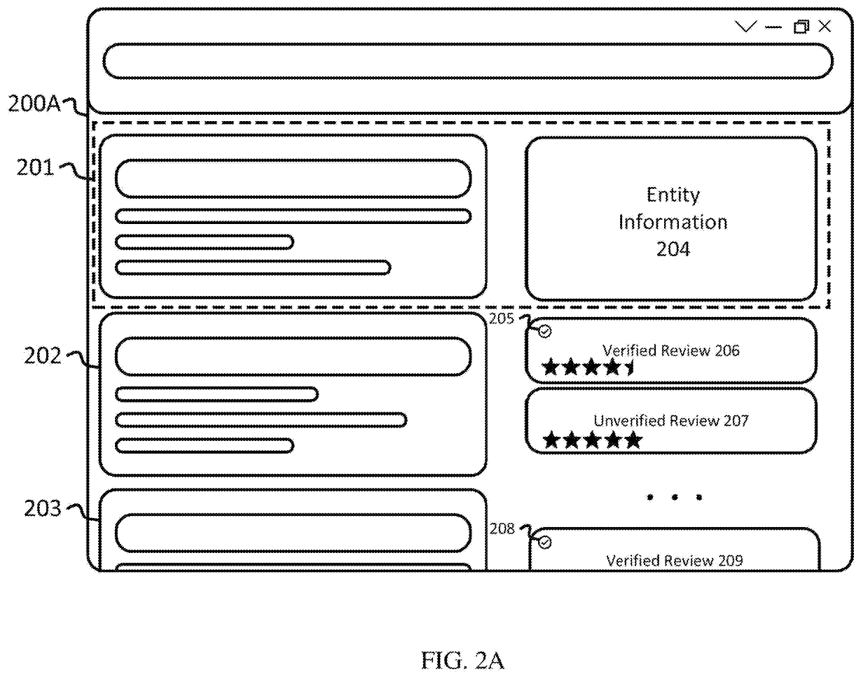

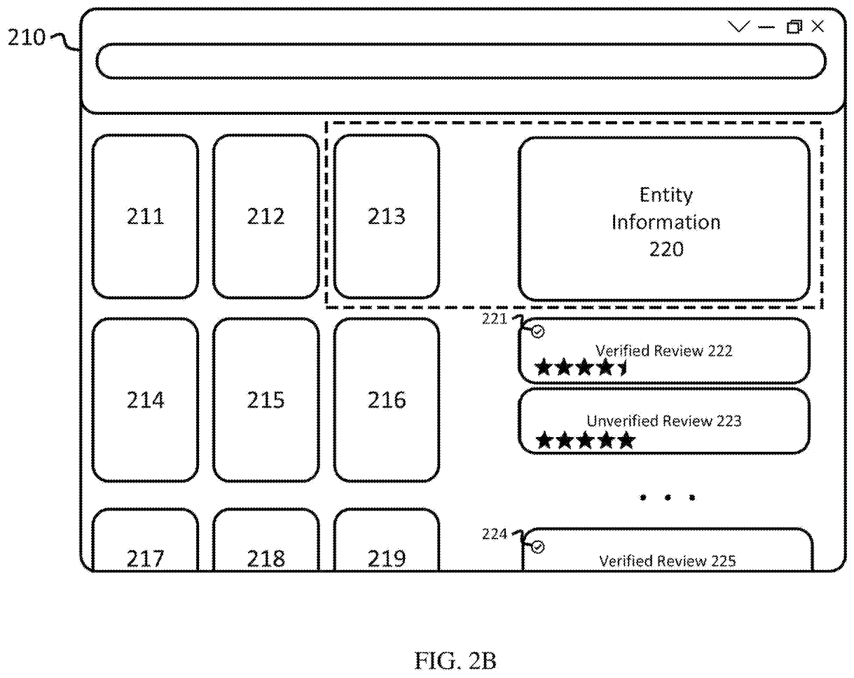

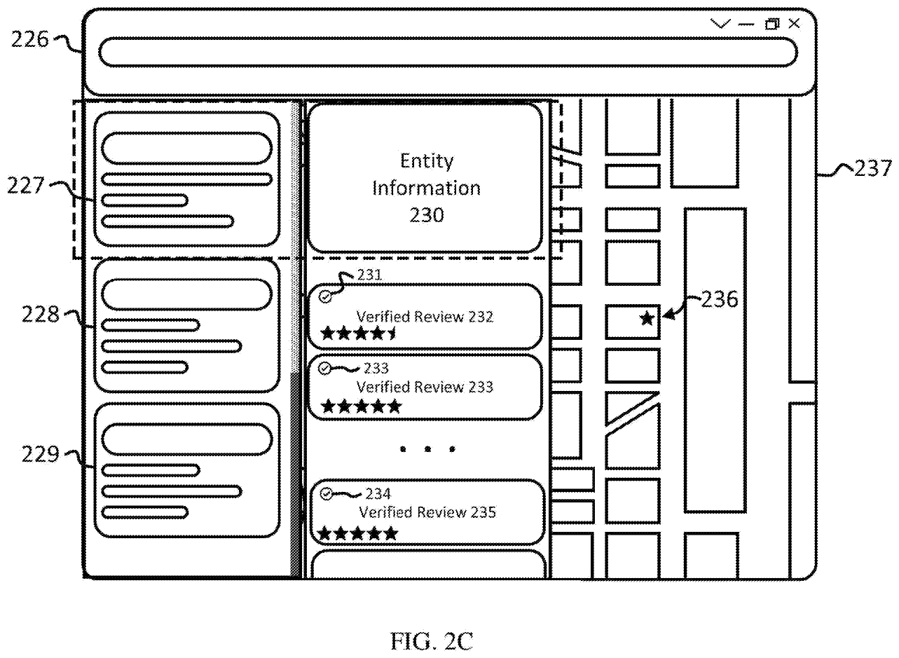

As described herein with reference to FIGS. 2A-2C, information corresponding to each entity—including verified and/or unverified reviews—can be provided to a requesting computing device. For example, the verified and/or unverified reviews may be provided as search results responsive to a query for a search engine implemented by the platform 500.

In some examples, the server computing device 515 or another device on the computing platform 500 can implement a content recommendation engine 101. The content recommendation engine 101 can be configured for analyzing, ranking, and/or serving content on the platform 500 to requesting devices, such as the user computing device 125.

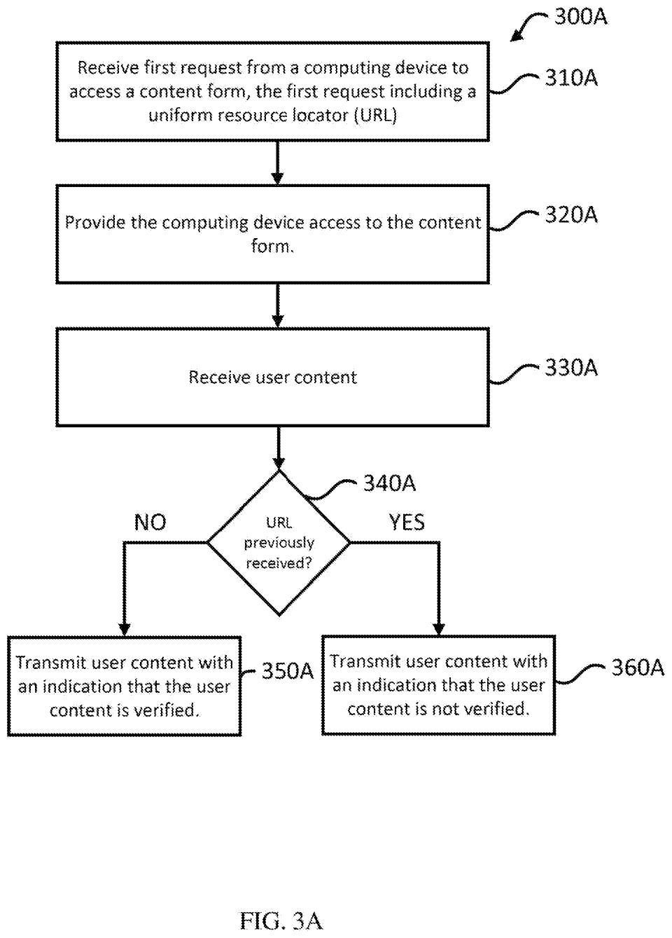

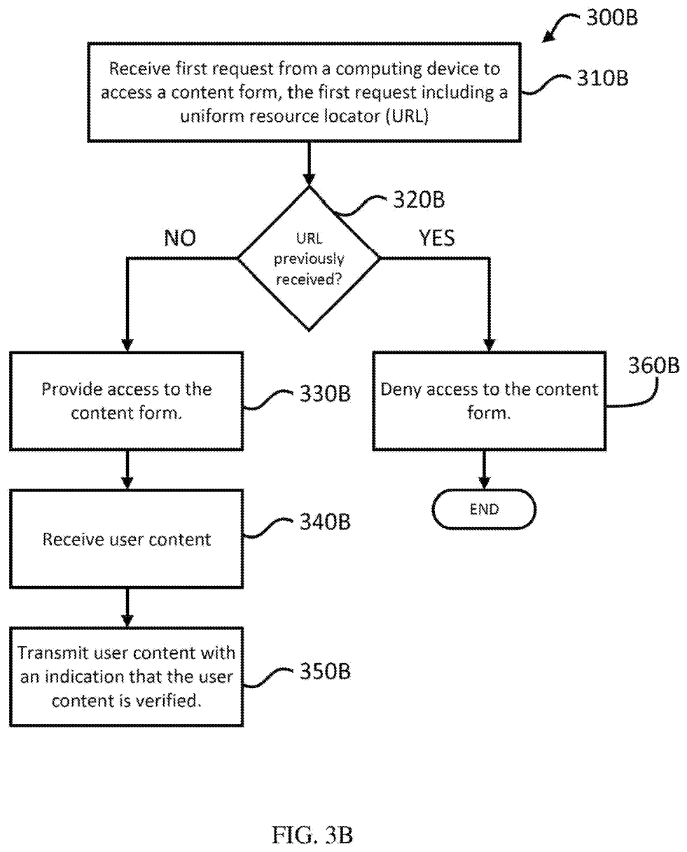

For example, the computing platform 500 may implement a search engine, with an example interface shown and described with reference to FIGS. 2A-C. As part of serving content, the content recommendation engine 101 may rank, e.g., rearrange the order in which content is displayed, at least partially based on verified and unverified reviews associated with the content. For example, entities whose information is responsive to a search engine request may be weighted more heavily in appearing higher up in the search results, based on the presence of verified reviews. Additionally, more verified reviews can be used to distinguish search results that are more or less responsive to a user query, versus unverified reviews, in which their origins are less certain. As described herein, aspects of the disclosure can increase the overall number of verified reviews from transactions, including those performed outside of the platform that may be publishing the verified reviews. FIGS. 3A-3B show example flow diagrams for receiving and handling requests by the UGC verification system 100.

FIG. 2A illustrates a web page 200 on a device displaying verified user reviews, according to aspects of the disclosure. Search results 201-203 can be provided by a platform implementing the UGC verification system, for example a computing platform implementing a search engine. The search results 201-203 can be responsive to a query received by the platform. An example query can be “restaurants near me,” to search for restaurants within a predetermined physical radius of a location of a device sending the query.

Entity information 204 can be a detailed view of information related to a search result, such as search result 201. Reviews 206-209 can also be displayed, associated with an entity represented by the search result 201. The verified reviews 206, 209 can include a rating, for example on a one-to-five-star rating, as well as comments or other content provided by a user through a content form linked by an encoded URL generated by the UGC verification system 100. The verified reviews 206, 209 can be indicated, for example, with icons 205, 208 or text. Unverified reviews, such as unverified review 207 may also be published, but will appear without an icon or other verification indicator.

FIG. 2B illustrates a web page on a device displaying verified user reviews corresponding to media elements 211-219 of a media gallery, according to aspects of the disclosure. Media elements 211-219 can represent images, audio clips, videos, or other types of media, for example provided in response to a search query or retrieved from a local or online media repository. Media element 213 may be selected, for example through user input such as a touchscreen press or mouse click. A platform implementing the UGC verification system 100 can determine, for example through a predetermined label or a learned label using machine learning or similar technique, an entity represented by the media element 213. For example, the media element 213 may be an image of a restaurant. Entity information 220 can correspond, for example, to the restaurant. Verified reviews 222 and 225 are indicated by verification icons 221, 224, respectively. Review 223 is unverified.

FIG. 2C illustrates a web page 226 on a device displaying verified user reviews for an entity location displayed on a digital map 237. Search results 227-229 can be displayed in addition to the digital map 237 displaying a location 236, for example corresponding to the location of an entity represented in search result 227 and entity information 230. For example, in response to a search query, a platform implementing the UGC verification system 100 can respond with verified reviews for selected results provided in response to the query.

FIGS. 2A-C illustrate how the UGC verification system can augment existing systems in which user reviews are published, whether through search engine results, a media gallery, and/or a map or navigation application.

### Example Methods

FIG. 3A is a flow diagram of an example process 300A for responding to requests for generating user-verified content, according to aspects of the disclosure. According to the process 300A, the system provides a content form regardless of whether or not the URL has been previously accessed. However, the system will only indicate that the content received through the form is verified if the URL has not been previously received.

The UGC verification system receives a first request from a computing device to access a content form, according to block 310A. The first request can include a URL, which as described herein can be encoded and uniquely generated by the UGC verification system.

The UGC verification system provides the requesting computing device access to the content form, according to block 320A.

The UGC verification system receives user content, according to block 330A. The user content can be received through a user-interactable element, such as a textbox, embedded in the content form.

The UGC verification system determines whether the URL in the first request has been previously received, according to decision block 340A. If the URL has not been previously received (“NO”), then the UGC verification system transmits the received user content to one or more computing devices with an indication that the user content is verified, according to block 350A. Otherwise (“YES”), the UGC verification system transmits the received user content to one or more computing devices with an indication that the user content is not verified, according to block 360A.

FIG. 3B is a flow diagram of an example process for responding to requests for generating unverified user content, according to aspects of the disclosure.

As described herein with reference to FIG. 3A, the UGC verification system receives a first request and determines whether the URL in the first request has been previously received, according to 310B and 320B, respectively. If the UGC verification system determines that the URL has not been previously received (“NO”), then the UGC verification system can provide access to the content form, receive user-generated content, and transmit user content with an indication that the user content is verified, according to blocks 330B, 340B, and 350B, respectively. Otherwise, if the URL is determined to have been previously received (“YES”), then the system can deny access to the content form, according to block 360B.

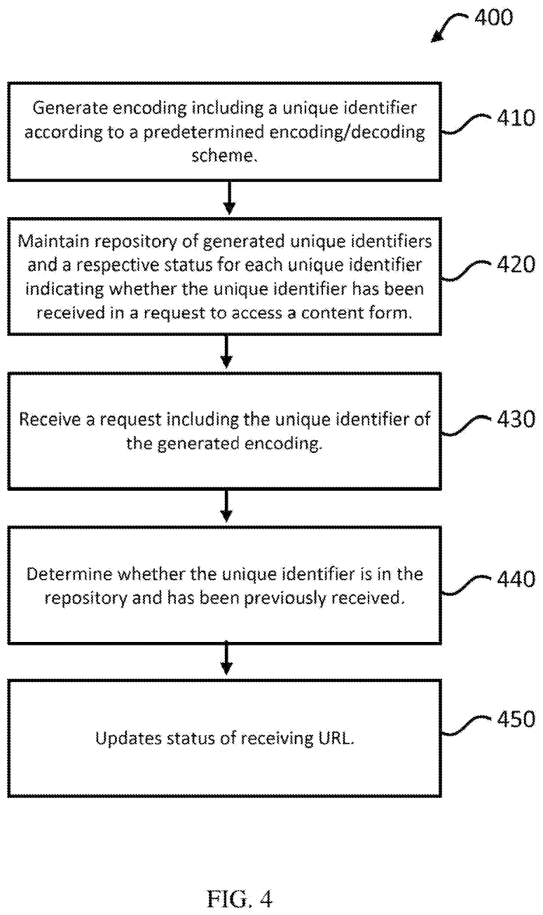

FIG. 4 is a flow diagram of an example process 400 for determining whether a request through an encoded URL has been previously received, according to aspects of the disclosure.

The UGC verification system generates an encoding including a unique identifier and according to a predetermined encoding/decoding scheme, according to block 410. The URL and encoding can be generated by the UGC verification system in response to receiving a request from a POS system executing a transaction for an encoding. The unique identifier can be a URL generated for the transaction, and optionally using metadata corresponding to the transaction, such as a location of the POS system and/or a timestamp indicating the time of the transaction.

The UGC verification system maintains a repository of generated unique identifiers and a respective status for each unique identifier indicating whether the unique identifier has been received in a request to access a content form, according to block 420.

The UGC verification system receives a request including a URL, according to block 430. The request can be received from a computing device receiving user input for interacting with an encoding or a URL.

The UGC verification system determines whether the unique identifier is in the repository and has been previously received, according to block 440. If the unique identifier has not been previously received, the UGC verification system determines that the URL has not been previously received (“YES” in decision blocks 340A, 320B), otherwise, the UGC verification system determines that the URL has been previously received (“NO” in decision blocks 340A, 320B).

The UGC verification system updates the status of the receiving URL, according to block 450. The status is maintained in the repository and used to track whether the URL has been previously received. Initially the status of the URL can be set to a value indicating that the URL has not been previously received. After receiving

### Example Computing Environment

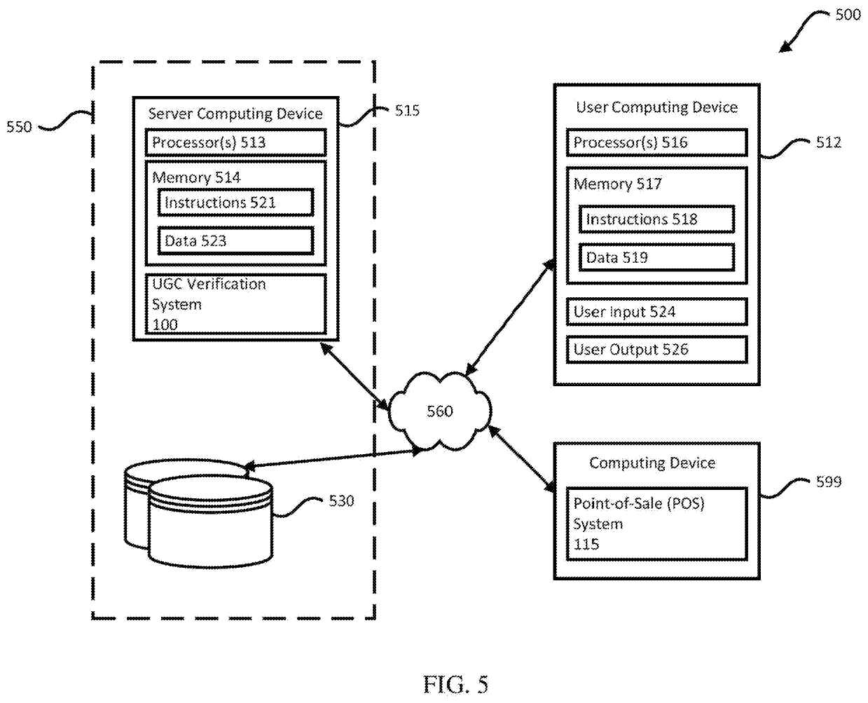

FIG. 5 is a block diagram of an example computing environment 500 implementing the UGC verification system 100, according to aspects of the disclosure. The system 100 can be implemented on one or more devices having one or more processors in one or more locations, such as in server computing device 515. User computing device 512 and the server computing device 515 can be communicatively coupled to one or more storage devices 530 over a network 560. The storage device(s) 530 can be a combination of volatile and non-volatile memory and can be at the same or different physical locations than the computing devices 512, 515. For example, the storage device(s) 530 can include any type of non-transitory computer readable medium capable of storing information, such as a hard-drive, solid state drive, tape drive, optical storage, memory card, ROM, RAM, DVD, CD-ROM, write-capable, and read-only memories. The storage device(s) 530 can include repository 130 in which server computing device 515 maintains unique identifiers and statuses representing the use of the identifiers, as described herein.

The server computing device 515 can include one or more processors 513 and memory 514. The memory 514 can store information accessible by the processor(s) 513, including instructions 521 that can be executed by the processor(s) 513. The memory 514 can also include data 523 that can be retrieved, manipulated or stored by the processor(s) 513. The memory 514 can be a type of non-transitory computer readable medium capable of storing information accessible by the processor(s) 513, such as volatile and non-volatile memory. The processor(s) 513 can include one or more central processing units (CPUs), graphic processing units (GPUs), field-programmable gate arrays (FPGAs), and/or application-specific integrated circuits (ASICs), such as tensor processing units (TPUs).

The instructions 521 can include one or more instructions that when executed by the processor(s) 513, causes the one or more processors to perform actions defined by the instructions. The instructions 521 can be stored in object code format for direct processing by the processor(s) 513, or in other formats including interpretable scripts or collections of independent source code modules that are interpreted on demand or compiled in advance. The instructions 521 can include instructions for implementing the system 100 in accordance with aspects of this disclosure. The system 100 can be executed using the processor(s) 513, and/or using other processors remotely located from the server computing device 515.

The data 523 can be retrieved, stored, or modified by the processor(s) 513 in accordance with the instructions 521. The data 523 can be stored in computer registers, in a relational or non-relational database as a table having a plurality of different fields and records, or as JSON, YAML, proto, or XML documents. The data 523 can also be formatted in a computer-readable format such as, but not limited to, binary values, ASCII or Unicode. Moreover, the data 523 can include information sufficient to identify relevant information, such as numbers, descriptive text, proprietary codes, pointers, references to data stored in other memories, including other network locations, or information that is used by a function to calculate relevant data.

The user computing device 512 can also be configured similar to the server computing device 515, with one or more processors 516, memory 517, instructions 518, and data 519. The user computing device 512 can also include a user output 526, and a user input 524. The user input 524 can include any appropriate mechanism or technique for receiving input from a user, such as a keyboard, a mouse, mechanical actuators, soft actuators, touchscreens, microphones, and sensors.

A computing device 599 can implement a point-of-sale system, for example the point-of-sale system 115 as shown and described with reference to FIG. 1. The computing device 599 can be connected to the server computing device 515 and the user computing device 512 over the network 560.

The server computing device 515 can be configured to transmit data to the user computing device 512, and the user computing device 512 can be configured to display at least a portion of the received data on a display implemented as part of the user output 526. The user output 526 can also be used for displaying an interface between the user computing device 512 and the server computing device 515. The user output 526 can alternatively or additionally include one or more speakers, transducers or other audio outputs, a haptic interface or other tactile feedback that provides non-visual and non-audible information to the platform user of the user computing device 512.

Although FIG. 5 illustrates the processors 513, 516 and the memories 514, 517 as being within the computing devices 515, 512, components described in this specification, including the processors 513, 516 and the memories 514, 517 can include multiple processors and memories that can operate in different physical locations and not within the same computing device. For example, some of the instructions 521, 518 and the data 523, 519 can be stored on a removable SD card and others within a read-only computer chip. Some or all of the instructions and data can be stored in a location physically remote from, yet still accessible by, the processors 513, 516. Similarly, the processors 513, 516 can include a collection of processors that can perform concurrent and/or sequential operations. The computing devices 515, 512 can each include one or more internal clocks providing timing information, which can be used for time measurement for operations and programs run by the computing devices 515, 512.

The server computing device 515 can be configured to receive requests to process data from the user computing device 512. For example, the environment 500 can be part of a computing platform configured to provide a variety of services to users, through various user interfaces and/or APIs exposing the platform services.

The devices 512, 515, 599 can be capable of direct and indirect communication over the network 560. The devices 515, 512, 599 can set up listening sockets that may accept a connection for sending and receiving information. The network 560 itself can include various configurations and protocols including the Internet, World Wide Web, intranets, virtual private networks, wide area networks, local networks, and private networks using communication protocols proprietary to one or more companies. The network 560 can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network 560, in addition or alternatively, can also support wired connections between the devices 512, 515, 599, including over various types of Ethernet connection.

Although a single server computing device 515, user computing device 512, and computing device 599 are shown in FIG. 5, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more processors, causes the one or more processors to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

With respect to the use of substantially any plural and/or singular terms herein, for example (with the term “element” being a stand-in for any system, component, data, etc.) “an/the element,” “one or more elements,” “multiple elements,” a “plurality of elements,” “at least one element,” etc., those having skill in the art can translate from the plural to the singular and/or from the singular to the plural as is appropriate to the context and/or application described. The various singular/plural permutations may be expressly set forth herein, for the sake of clarity and without limitation, unless expressly indicated.

1. A method comprising:
receiving, by one or more processors, a first request from a computing device to access a content form, the first request comprising a uniform resource locator (URL);
determining, by the one or more processors, that the URL of the first request was not previously received in another request; and
in response to determining that the URL of the first request was not previously received in another request, providing, by the one or more processors, the computing device access to the content form.

2. The method of claim 1, further comprising:
generating, by the one or more processors, an encoding of the URL according to a predetermined encoding/decoding scheme.

3. The method of claim 2, wherein the encoding is a quick response (QR) code or a data matrix code.

4. The method of claim 2, further comprising:
transmitting, by the one or more processors, the encoding of the URL to the computing device.

5. The method of claim 2, further comprising:
transmitting, by the one or more processors, the encoding of the URL to a point-of-sale (POS) system in response to receiving an indication of a transaction of a good or service executed by the POS system.

6. The method of claim 5, wherein the encoding further includes metadata comprising one or more of:
data characterizing the transaction,
data characterizing the POS system, or
data characterizing the computing device.

7. The method of claim 5,
wherein the content form comprises a user-interactable element for a user review of an entity that is a party to the transaction of the good or service, and
wherein the method further comprises:
receiving, by the one or more processors, user content through the user-interactable element of the content form; and
in response to determining the URL of the first request was not previously received in another request, transmitting, by the one or more processors, the user content to one or more computing devices with an indication that a user associated with the user content is a party to the transaction.

8. The method of claim 7, further comprising:
determining, by the one or more processors, that the URL of the first request was previously received in another request, and in response,
providing, by the one or more processors, the computing device access to the content form,
receiving, by the one or more processors, the user content through the user-interactable element of the content form, and
transmitting, by the one or more processors, the user content to the one or more computing devices with an indication that a user associated with the user content is not party to the transaction of the good or service.

9. The method of claim 2,
wherein the encoding encodes a unique identifier, and
wherein determining, by the one or more processors, that the URL of the first request was previously received comprises maintaining a repository of generated unique identifiers and a respective status for each unique identifier indicating whether the unique identifier has been received in a request to access a content form.

10. The method of claim 9, wherein the unique identifier is the encoded URL.

11. A system, comprising:
one or more processors, the one or more processors configured to:
receive a first request from a computing device to access a content form, the first request comprising a uniform resource locator (URL);
determine that the URL of the first request was not previously received in another request; and
in response to the determining that the URL of the first request was not previously received in another request, provide the computing device access to the content form.

12. The system of claim 11, wherein the one or more processors are further configured to:
generate an encoding of the URL according to a predetermined encoding/decoding scheme.

13. The system of claim 12, wherein the encoding is a quick response (QR) code or a data matrix code.

14. The system of claim 12, wherein the one or more processors are further configured to transmit the encoding of the URL to the computing device.

15. The system of claim 12, wherein the one or more processors are further configured to transmit the encoding of the URL to a point-of-sale (POS) system in response to receiving an indication of a transaction of a good or service executed by the POS system.

16. The system of claim 15, wherein the encoding further includes metadata comprising one or more of:
data characterizing the transaction,
data characterizing the POS system, or
data characterizing the computing device.

17. The system of claim 15,
wherein the content form comprises a user-interactable element for a user review of an entity that is a party to the transaction of the good or service, and
wherein the one or more processors are further configured to:
receive user content through the user-interactable element of the content form; and
in response to the determination that the URL of the first request was not previously received in another request, transmit, by the one or more processors, the user content to one or more computing devices with an indication that a user-author of the content is a party to the transaction.

18. The system of claim 17, wherein the one or more processors are further configured to:
determine that the URL of the first request was previously received in another request, and in response, provide the computing device access to the content form,
receive the user content through the user-interactable element of the content form, and
transmit the user content to the one or more computing devices with an indication that a user associated with the user content is a party to the transaction.

19. The system of claim 12,
wherein the encoding encodes a unique identifier, and
wherein in determining that the URL of the first request was previously received, the one or more processors are configured to maintain a repository of generated unique identifiers and a respective status for each unique identifier indicating whether the unique identifier has been received in a request to access a content form; and optionally
wherein the unique identifier is the encoded URL.

20. A computer-readable storage media storing instructions that are operable, when executed be one or more processors, to cause the one or more processors to:
receive a first request from a computing device to access a content form, the first request comprising a uniform resource locator (URL);
determine that the URL of the first request was not previously received in another request; and
in response to the determining that the URL of the first request was not previously received in another request, provide the computing device access to the content form.
